(19) United States
(12) Patent Application Publication
(10) Pub. No.: US 2026/0170374 A1
(43) Pub. Date: Jun. 18, 2026

(54) Three-Dimensional Capture Data System For Bloch Spheres And Quantum Gates

(71) Applicant: INTERNATIONAL BUSINESS MACHINES CORPORATION, ARMONK, NY (US)

(72) Inventor: Juan Venancio SPINDOLA NAVARRO, Mexico City (MX)

(21) Appl. No.: 18/983,201

(22) Filed: Dec. 16, 2024

(51) Int. Cl. G06N 10/20; G06N 10/80

(52) U.S. Cl. CPC G06N 10/20; G06N 10/80

(57) ABSTRACT

A quantum state visualization device includes one or more spheres with one or more sensors within each of the one or more spheres. A classical computing machine determines movement of each of the one or more spheres and converts said movement into a spherical rotation of each of the one or more spheres. The spherical rotation is implemented into a quantum circuit.

### BACKGROUND

The present disclosure generally relates to systems and methods for interacting with a three-dimensional representation of a qubit, such as a Bloch sphere, and more particularly, to a method, a computer system, and a computer program product for providing a three-dimensional capture data system for Bloch Spheres and quantum gates.

Hereinafter, a “Q” prefix in a word of phrase is indicative of a reference of that word or phrase in a quantum computing context unless expressly distinguished where used.

Molecules and subatomic particles follow the laws of quantum mechanics, a branch of physics that explores how the physical world works at the most fundamental levels. At this level, particles behave in strange ways, taking on more than one state at the same time, and interacting with other particles that are very far away. Quantum computing harnesses these quantum phenomena to process information.

The computers used today are known as classical computers (also referred to herein as “conventional” computers or conventional nodes, or “CN”). A conventional computer uses a conventional processor fabricated using semiconductor materials and technology, a semiconductor memory, and a magnetic or solid-state storage device, in what is known as a Von Neumann architecture. Particularly, the processors in conventional computers are binary processors, i.e., operating on binary data represented in 1 and 0.

A quantum processor (q-processor) uses the odd nature of entangled qubit devices (compactly referred to herein as “qubit,” plural “qubits”) to perform computational tasks. In the particular realms where quantum mechanics operates, particles of matter can exist in multiple states-such as an “on” state, an “off” state, and both “on” and “off” states simultaneously. Where binary computing using semiconductor processors is limited to using just the on and off states (equivalent to 1 and 0 in binary code), a quantum processor harnesses these quantum states to output signals that are usable in data computing.

Conventional computers encode information in bits. Each bit can take the value of 1 or 0. These 1s and 0s act as on/off switches that ultimately drive computer functions. Quantum computers, on the other hand, are based on qubits, which operate according to two key principles of quantum physics: superposition and entanglement. Superposition means that each qubit can represent both a 1 and a 0 at the same time. Entanglement means that qubits in a superposition can be correlated with each other in a non-classical way; that is, the state of one (whether it is a 1 or a 0 or both) can depend on the state of another, and that there is more information that can be ascertained about the two qubits when they are entangled than when they are treated individually.

Using these two principles, qubits operate as more sophisticated processors of information, enabling quantum computers to function in ways that allow them to solve difficult problems that are intractable using conventional computers. IBM has successfully constructed and demonstrated the operability of a quantum processor using superconducting qubits (IBM is a registered trademark of International Business Machines corporation in the United States and in other countries.)

### SUMMARY

In one embodiment, a method and a computer program product can be configured for capturing data related to movement of a spherical body and implementing the spherical rotation into a quantum circuit.

In one embodiment, a system includes a movable object and one or more sensors within the movable object to detect movement of the movable object. A classical computing machine determines movement of the movable object and converts said movement into a rotation of the movable object. The rotation data can be implemented into a quantum circuit.

In another embodiment, a quantum state visualization device includes one or more spheres and one or more sensors within each of the one or more spheres. A classical computing machine determines movement of each of the one or more spheres and converts said movement into a spherical rotation of each of the one or more spheres. The spherical rotation can be implemented into a quantum circuit.

In another embodiment, a method for visualizing a quantum state on a three-dimensional quantum state visualization device includes manipulating one or more spheres and determining spherical rotation of each of the one or more spheres with one or more sensors disposed within each of the one or more spheres. The spherical rotation is implemented into a quantum circuit, and the quantum state of the quantum circuit is shown on a display.

These and other features will become apparent from the following detailed description of illustrative embodiments thereof, which is to be read in connection with the accompanying drawings.

### BRIEF DESCRIPTION OF THE DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all the components or steps that are illustrated. When the same numeral appears in different drawings, it refers to the same or like components or steps.

FIG. 1 is an illustration of a Block sphere, showing a visualized quantum state, consistent with an illustrative embodiment;

FIG. 2 is an illustration of a sphere for manipulation to changes a visualized quantum state, consistent with an illustrative embodiment;

FIG. 3 is an illustration of examples of devices usable for the manipulation of the sphere of FIG. 2;

FIG. 4 is an illustration of user-manipulation of the sphere of FIG. 2;

FIG. 5 is a flow chart showing use of the sphere of FIG. 2, illustrating various different rotational movements that can be operated thereupon, consistent with an illustrative embodiment;

FIG. 6 is a flow chart illustrating a method, consistent with an illustrative embodiment;

FIG. 7 is a flow chart illustrating another method, consistent with an illustrative embodiment; and

FIG. 8 is a block depiction of a classical computer hardware platform for providing systems for interacting with a three-dimensional representation of a qubit, consistent with illustrative embodiments.

### DETAILED DESCRIPTION

In the following detailed description, numerous specific details are set forth by way of examples to provide a thorough understanding of the relevant teachings. However, it should be apparent that the present teachings may be practiced without such details. In other instances, well-known methods, procedures, components, and/or circuitry have been described at a relatively high-level, without detail, to avoid unnecessarily obscuring embodiments of the present teachings.

### Definitions

Quantum circuit, as used herein, is a circuit with an ordered sequence of quantum gates. At the end of every quantum circuit, there is measurement operation that collapses the quantum state of the qubit classically. The measurement can be expectation value of an operator or probability values of computational basis states.

Qubit (or quantum bits), as used herein, refers to a basic unit of quantum information using the classic binary bit physically realized with a two-state device. Qubits are quantum equivalent of classical bits. While classical bits only have either 0 or 1 values, a qubit can have a range of values, which can be, in general, represented as a quantum state

$$\vert φ 〉 = [ \begin{matrix}α \\ β\end{matrix} ] ,$$

where |α²| represents the probability of the qubit being measured to 0, and |β²| represents the probability of the qubit being measured to 1. A qubit has two special states |0 [symbol] with α=1, β=0 and |1 [symbol] with α=0, β=1. These states are called computational basis states.

Bloch sphere, as used herein, refers to a geometrical representation of the pure state space of a two-level quantum mechanical system (qubit).

### Overview

Embodiments of the present disclosure are directed toward devices for adjusting the state of a qubit, and, more specifically, to devices and methods for adjusting the quantum state of one or more qubits in quantum computing. While not limited to such applications, some features of the present disclosure may be better understood in light of the aforementioned context.

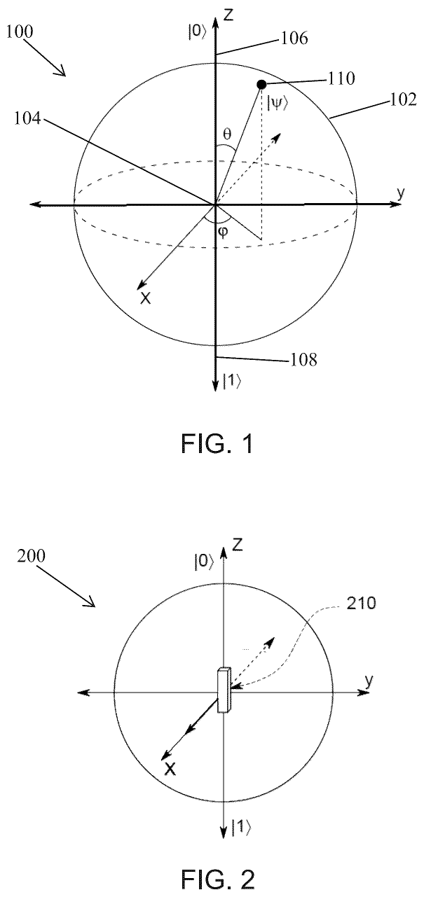

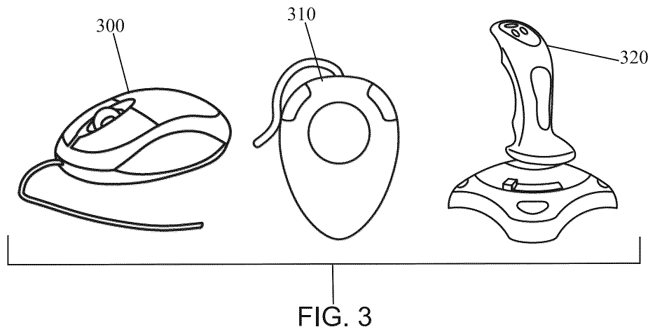

The matrix representation of a qbit Ψ implies the requirement that it must be a normalized physical state. Given the above, the coefficients that represent the state matrix of a qbit describing a 3-dimensional sphere, whose center is located at the origin and with radius equal to 1. The Bloch sphere 100 of FIG. 1 is thus a geometric representation of the space of pure states of a two-level quantum system, it is a sphere of unitary radius in which each point corresponds univocally to a pure state of the two-dimensional Hilbert space.

The system described herein can be used to represent any point on the surface on the Bloch sphere 100 as well as quantum gates, since these quantum gates are defined in terms of angles. A set of sensor devices, as described in greater detail below, act inside a physical spherical body which can be manipulated either manually by physically adjusting the orientation of the sphere, or through software instructions. Multiple types of operations can be applied to transform the position of the physical device to meet various objectives.

The sensor devices can be magnetic, accelerometric, gyroscopic or a combination of them, in addition to using software methods to locate the vector point and thus move the sphere to represent the requested quantum gates. The position of the vector on the surface of the sphere can also be manipulated manually, since a sensor device is included within the sphere. Quantum gates can be captured in the system through software methods that move the real coordinates on the sphere to the corresponding point of each gate.

Quantum computing is a challenging field to learn, especially for people without a background in higher-level physics and mathematics. In order to educate people about quantum computing, it is helpful to have interactive learning devices that aid educators, students, and professionals in intuitively grasping fundamental concepts associated with quantum computing.

One such fundamental concept associated with quantum computing relates to quantum states of quantum bits (qubits or qbits). Qubits are the basic unit of quantum information in quantum computing and serve a similar function as binary bits do in classical computing. However, while binary bits can exist in only one of two possible states, qubits can exist in a combination (i.e., superposition) of two possible states.

FIG. 1 illustrates a generic Bloch sphere 100, in accordance with embodiments of the present disclosure. Bloch sphere 100 includes a spherical surface 102 defined in a 3D space represented using an x-axis, y-axis, and z-axis intersecting each other at center 104 (i.e., origin). The Bloch sphere 100 includes two antipodal points (e.g., sometimes referred to as the north-pole and south-pole points) representing a first basis vector 106 corresponding to the quantum state |0 [symbol] (e.g., ground state vector) and a second basis vector 108 corresponding to the quantum state |1 [symbol] (e.g., opposite state vector). The Bloch sphere 100 further includes a visualized quantum state 110 that is represented by the notation |ψ [symbol] and defined by an angle θ relative to the z-axis, an angle φ relative to the x-axis, and a distance r (for pure states, distance r equals the radius of the spherical surface 102, while for mixed states, distance r is less than the radius of the spherical surface 102). Thus, Bloch sphere 100 enables a visualized quantum state 110 (e.g., |ψ [symbol] ) to be represented using spherical, cylindrical, or Euclidean coordinates in 3D space, where the visualized quantum state 110 intersects the center 104 of the spherical surface 102. Embodiments of the present disclosure are directed to a quantum state visualization device embodying, in three dimensions, a Bloch sphere 100 and capable of showing a visualized quantum state 110 using an indicator that moves about the spherical surface 102 based on user manipulation and a device for capturing the manipulations performed by the user, either manually, directly to the sphere, through another device (such as a track ball, mouse, joystick, or the like, or via software manipulation.

The various quantum states of a qubit can be represented by a Bloch sphere 100, as shown in FIG. 1. As is understood by one of skill in the art, the Bloch sphere represents the theoretical three-dimensional (3D) state space of a qubit. However, Bloch spheres are traditionally presented on two-dimensional (2D) media such as paper and electronic screens. Viewing Bloch spheres on 2D media is less intuitive than a physical representation of a Bloch sphere in 3D. Some embodiments of the present disclosure are directed to a physical, 3D quantum state visualization and data capture device for visualizing, in 3D, the representations of a Bloch sphere and for capturing data related to the rotational positions thereof.

The 3D quantum state visualization device can be augmented with controls enabling a user to view different quantum states, and, in some embodiments, view the trajectory of a change from one quantum state to another quantum state (e.g., as a qubit interacts with one or more quantum logic gates in a quantum system). Collectively, the 3D quantum state visualization device discussed herein enables users to better understand quantum mechanics, and, in particular, quantum states of qubits.

The system, as illustrated in FIG. 2, includes a solid sphere 200 (also referred to as the 3D quantum state visualization device) that can be made of some rigid material, rubber capable of bouncing, or the like, with an internal device 210 which is capable of sensing changes in orientation in the three coordinate axes. In addition, the sphere 200 can include a battery 220, such as a rechargeable battery, to power the internal device 210. The battery 220 may be part of the internal device 210, as illustrated, or may be separate from the internal device 210 but electrically connected thereto.

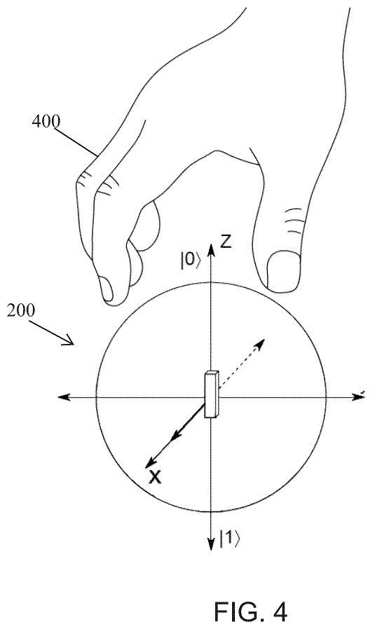

The internal device 210 can be gyroscopic, magneto-resistive, accelerometric, or a combination of one or more of these features. The sphere 200 can be embedded inside some mechanism such as a mouse 300, trackball 310, joystick 320 or even the sphere 200 can stand alone by itself. In some embodiments, the sphere 200 may be directly manipulated by a user 400, as illustrated in FIG. 4.

The internal device 210 can be connected to a center of the sphere 200 (i.e., the origin). The internal device 210 can be attached to the spherical shell at one, two, or a different number of connection points. The sphere 200 can be articulated to represent different quantum states. The sphere 200 can be moved based on manual input (e.g., a user providing rotational and/or translational forces directly to a sphere 200) or to a device holding the sphere 200.

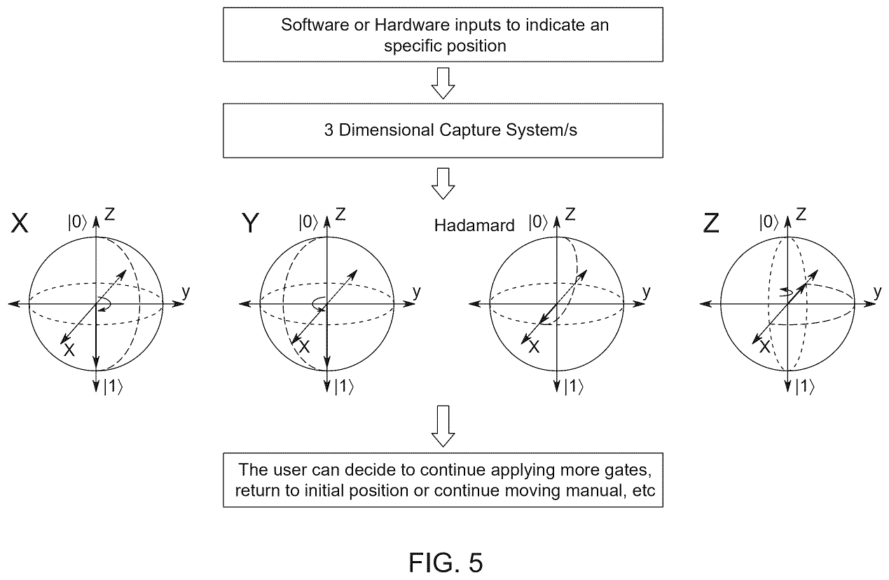

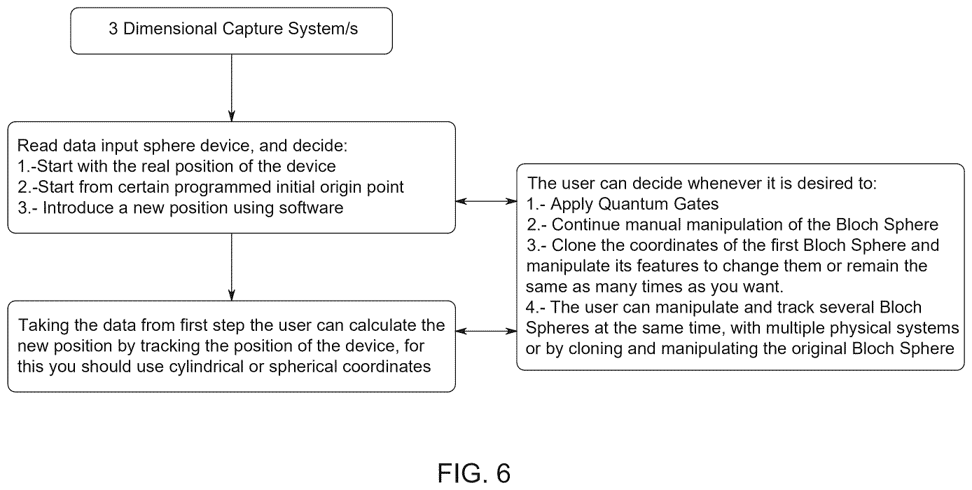

Thus, as shown in FIGS. 5 and 6, with the use of the sphere 200 embedded in some mechanism such as a mouse, joystick, trackball or some other variant, or without being subject to any other mechanism, by making the sphere 200 rotate manually on any of its axes, the sphere 200 can send an updated orientation to a software to calculate the position of the vector representative of the qubit, and then be graphed and subsequently represented in a Bloch sphere.

In addition to the above, quantum gates can also be represented and applied with this system, since they are angular rotations about certain x, y, and z axes or a combination of several axes. Thus, using another software or hardware command, a user can, if desired, return the sphere 200 to the initial position that the system has registered in memory, or the user can continue applying commands to represent more quantum gates with the system and manipulate them to the user's liking. FIG. 5 shows examples of a first manipulation 500 along the X axis, a second manipulation 510 along the Y axis, a third manipulation 520 performed according to a Hadamard matrix, and a fourth manipulation 530 along a Z axis. Of course, combinations of such manipulations may also be performed. The user can decide at what point in the manipulation to apply quantum gate commands, through software or hardware, or continue experimenting with manual position changes, resetting the device or performing multiple combinations, and not only with a single sphere, but also with multiple spheres, thus establishing a programming interface with quantum computing libraries or Bloch sphere simulators that currently exist.

In summary, the system, according to embodiments of the present disclosure, presents a mechanism to manually or automatically enter coordinates or operations to represent quantum gates. The mechanism can be used within different devices, with a combination of hardware and software to interact with any currently existing Bloch Sphere simulator. The system can also be used to enter data through quantum computing programming languages or libraries.

Embodiments of the present disclosure exhibit numerous advantages including, but not limited to, the following list of example advantages realized by various features of the present disclosure. As a first example advantage, embodiments of the present disclosure provide 3D visualization of quantum states. This advantage is realized by the physical, three-dimensional structures making up the quantum state visualization device or sphere 200. This advantage improves over other techniques (e.g., 2D Bloch sphere representations) by allowing learners to visualize quantum states without having to perform a mental abstraction step from a 2D paper/screen representation of a Bloch sphere to the 3D reality the Bloch sphere represents.

As a second example advantage, embodiments of the present disclosure are capable of visualizing both pure quantum states (e.g., on the surface of the spherical shell of the 3D quantum state visualization device) and mixed quantum states (e.g., internal to the spherical shell of the 3D quantum state visualization device). This advantage enables users to intuitively understand pure quantum states and mixed quantum states. This advantage can be realized by having at least a portion of the sphere 200 fabricated from a transparent or semi-transparent material.

As a third example advantage, embodiments of the present disclosure are capable of visualizing specific quantum states (e.g., predefined quantum states such as a ground state). Visualizing specific quantum states is beneficial for performing directed education, where a student has one or more preset reference points from which to begin learning about quantum states.

As a fourth example advantage, embodiments of the present disclosure are capable of visualizing specific quantum state transitions between a first quantum state and a second quantum state. This fourth example advantage enables users to visualize a qubit transitioning from one quantum state to another quantum state via one or more quantum logic gates.

The aforementioned advantages are example advantages, and embodiments exist that can realize all of, some of, or none of the aforementioned advantages while remaining within the spirit and scope of the present disclosure.

### Example Methods

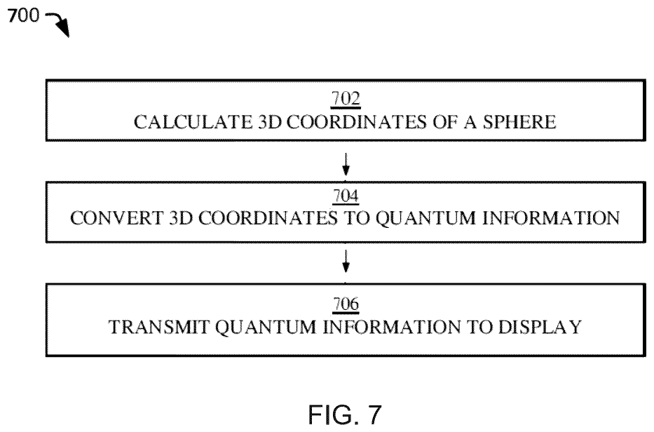

Referring to FIGS. 2 and 7, an example method 700 for converting a location of an X, Y, Z device, such as internal device 210 (see FIG. 2) in a sphere 200 into quantum state information is illustrated, in accordance with embodiments of the present disclosure. The method 700 can be implemented by a classical computing machine communicatively coupled to the sphere 200.

Operation 702 includes calculating 3D coordinates of the internal device 210 in the sphere 200. The 3D coordinates can be cylindrical coordinates, spherical coordinates, Euclidean coordinates, or a custom coordinate notation system useful for modifying the position of the indicator in the quantum state visualization device.

Operation 704 includes converting the 3D coordinates to quantum state information. The 3D coordinates can be converted to quantum state information using equations, algorithms, and/or transformations known in the art of quantum mechanics, particularly in relation to Hilbert spaces and/or Bloch spheres.

Operation 706 includes transmitting the quantum state information to a display, where the transmission enables the quantum state information to be presented on the display. The display can be, but is not limited to, a desktop, a laptop, a smartphone, a tablet, a screen, and so on. In some embodiments, operation 706 further includes transmitting educational content with the quantum state information, where the educational content can be an explanation, an instruction, a question, an equation, and/or different information.

### Example Computing Environment

Various embodiments of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

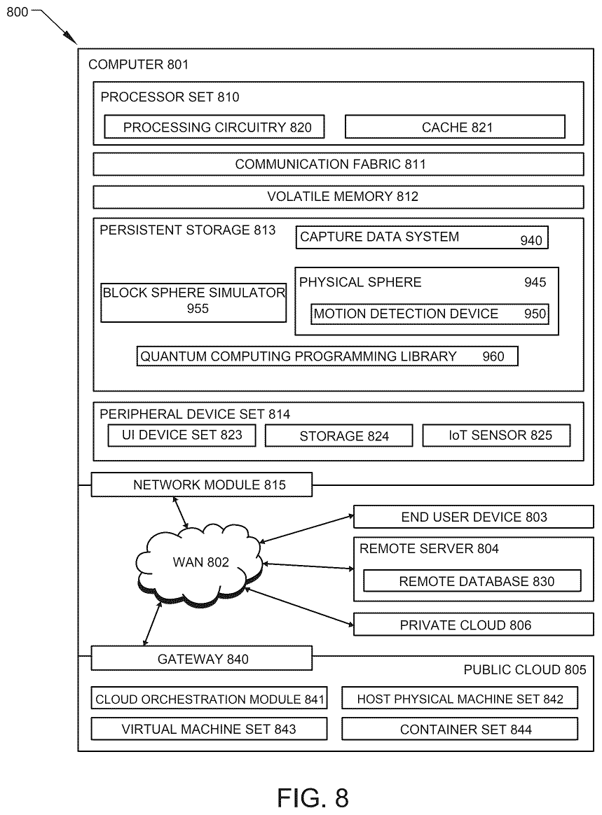

As shown in FIG. 8, classical computing environment 800 contains an example of an environment for the execution of at least some of the computer code involved in performing the inventive methods, such as, for example, some embodiments include a three-dimensional capture data system 940 that can provide a sphere for user manipulation to adjust the state of a quantum gate. In some embodiments, the capture data system 940 may include a physical sphere 945, having a motion detecting device 950 therein, that can be manipulated by a user and such motion can be determined by the capture data system 940. The capture data system 940 may exchange data with a Bloch sphere simulator 955 or a quantum computing programming library 960. The classical computing environment 800 can implement a classical computing machine that can further implement the spherical rotation into a quantum circuit. The capture data system 940 may operate according to one or more of the methods disclosed above. In addition to the capture data system 940, classical computing environment 800 includes, for example, computer 801, wide area network (WAN) 802, end user device (EUD) 803, remote server 804, public cloud 805, and private cloud 806. In this embodiment, computer 801 includes processor set 810 (including processing circuitry 820 and cache 821), communication fabric 811, volatile memory 812, persistent storage 813 (including operating system 822, as identified above), peripheral device set 814 (including user interface (UI) device set 823, storage 824, and Internet of Things (IoT) sensor set 825), and network module 815. Remote server 804 includes remote database 830. Public cloud 805 includes gateway 840, cloud orchestration module 841, host physical machine set 842, virtual machine set 843, and container set 844.

COMPUTER 801 may take the form of a desktop computer, laptop computer, tablet computer, smart phone, smart watch or other wearable computer, mainframe computer, or any other form of computer or mobile device now known or to be developed in the future that is capable of running a program, accessing a network or querying a database, such as remote database 830. As is well understood in the art of computer technology, and depending upon the technology, performance of a computer-implemented method may be distributed among multiple computers and/or between multiple locations. On the other hand, in this presentation of classical computing environment 800, detailed discussion is focused on a single computer, specifically computer 801, to keep the presentation as simple as possible. Computer 801 may be located in a cloud, even though it is not shown in a cloud in FIG. 8. On the other hand, computer 801 is not required to be in a cloud except to any extent as may be affirmatively indicated.

PROCESSOR SET 810 includes one, or more, computer processors of any type now known or to be developed in the future. Processing circuitry 820 may be distributed over multiple packages, for example, multiple, coordinated integrated circuit chips. Processing circuitry 820 may implement multiple processor threads and/or multiple processor cores. Cache 821 is memory that is located in the processor chip package(s) and is typically used for data or code that should be available for rapid access by the threads or cores running on processor set 810. Cache memories are typically organized into multiple levels depending upon relative proximity to the processing circuitry. Alternatively, some, or all, of the cache for the processor set may be located “off chip.” In some computing environments, processor set 810 may be designed for working with qubits.

Computer readable program instructions are typically loaded onto computer 801 to cause a series of operational steps to be performed by processor set 810 of computer 801 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 821 and the other storage media discussed below. The program instructions, and associated data, are accessed by processor set 810 to control and direct performance of the inventive methods. In classical computing environment 800, at least some of the instructions for performing the inventive methods may be stored in persistent storage 813.

COMMUNICATION FABRIC 811 is the signal conduction path that allows the various components of computer 801 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 812 is any type of volatile memory now known or to be developed in the future. Examples include dynamic type random access memory (RAM) or static type RAM. Typically, volatile memory 812 is characterized by random access, but this is not required unless affirmatively indicated. In computer 801, the volatile memory 812 is located in a single package and is internal to computer 801, but, alternatively or additionally, the volatile memory may be distributed over multiple packages and/or located externally with respect to computer 801.

PERSISTENT STORAGE 813 is any form of non-volatile storage for computers that is now known or to be developed in the future. The non-volatility of this storage means that the stored data is maintained regardless of whether power is being supplied to computer 801 and/or directly to persistent storage 813. Persistent storage 813 may be a read only memory (ROM), but typically at least a portion of the persistent storage allows writing of data, deletion of data and re-writing of data. Some familiar forms of persistent storage include magnetic disks and solid state storage devices.

PERIPHERAL DEVICE SET 814 includes the set of peripheral devices of computer 801. Data communication connections between the peripheral devices and the other components of computer 801 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 823 may include components such as a display screen, speaker, microphone, wearable devices (such as goggles and smart watches), keyboard, mouse, printer, touchpad, game controllers, and haptic devices. Storage 824 is external storage, such as an external hard drive, or insertable storage, such as an SD card. Storage 824 may be persistent and/or volatile. In embodiments where computer 801 is required to have a large amount of storage (for example, where computer 801 locally stores and manages a large database) then this storage may be provided by peripheral storage devices designed for storing very large amounts of data, such as a storage area network (SAN) that is shared by multiple, geographically distributed computers. IoT sensor set 825 is made up of sensors that can be used in Internet of Things applications. For example, one sensor may be a thermometer and another sensor may be a motion detector.

NETWORK MODULE 815 is the collection of computer software, hardware, and firmware that allows computer 801 to communicate with other computers through WAN 802. Network module 815 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 815 are performed on the same physical hardware device. In other embodiments (for example, embodiments that utilize software-defined networking (SDN)), the control functions and the forwarding functions of network module 815 are performed on physically separate devices, such that the control functions manage several different network hardware devices. Computer readable program instructions for performing the inventive methods can typically be downloaded to computer 801 from an external computer or external storage device through a network adapter card or network interface included in network module 815.

WAN 802 is any wide area network (for example, the internet) capable of communicating computer data over non-local distances by any technology for communicating computer data, now known or to be developed in the future. In some embodiments, the WAN 802 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 803 is any computer system that is used and controlled by an end user (for example, a customer of an enterprise that operates computer 801), and may take any of the forms discussed above in connection with computer 801. EUD 803 typically receives helpful and useful data from the operations of computer 801. For example, in a hypothetical case where computer 801 is designed to provide a recommendation to an end user, this recommendation would typically be communicated from network module 815 of computer 801 through WAN 802 to EUD 803. In this way, EUD 803 can display, or otherwise present, the recommendation to an end user. In some embodiments, EUD 803 may be a client device, such as thin client, heavy client, mainframe computer, desktop computer and so on.

REMOTE SERVER 804 is any computer system that serves at least some data and/or functionality to computer 801. Remote server 804 may be controlled and used by the same entity that operates computer 801. Remote server 804 represents the machine(s) that collect and store helpful and useful data for use by other computers, such as computer 801. For example, in a hypothetical case where computer 801 is designed and programmed to provide a recommendation based on historical data, then this historical data may be provided to computer 801 from remote database 830 of remote server 804.

PUBLIC CLOUD 805 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 805 is performed by the computer hardware and/or software of cloud orchestration module 841. The computing resources provided by public cloud 805 are typically implemented by virtual computing environments that run on various computers making up the computers of host physical machine set 842, which is the universe of physical computers in and/or available to public cloud 805. The virtual computing environments (VCEs) typically take the form of virtual machines from virtual machine set 843 and/or containers from container set 844. It is understood that these VCEs may be stored as images and may be transferred among and between the various physical machine hosts, either as images or after instantiation of the VCE. Cloud orchestration module 841 manages the transfer and storage of images, deploys new instantiations of VCEs and manages active instantiations of VCE deployments. Gateway 840 is the collection of computer software, hardware, and firmware that allows public cloud 805 to communicate through WAN 802.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 806 is similar to public cloud 805, except that the computing resources are only available for use by a single enterprise. While private cloud 806 is depicted as being in communication with WAN 802, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 805 and private cloud 806 are both part of a larger hybrid cloud.

### CONCLUSION

The descriptions of the various embodiments of the present teachings have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While the foregoing has described what are considered to be the best state and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications, and variations that fall within the true scope of the present teachings.

The components, steps, features, objects, benefits, and advantages that have been discussed herein are merely illustrative. None of them, nor the discussions relating to them, are intended to limit the scope of protection. While various advantages have been discussed herein, it will be understood that not all embodiments necessarily include all advantages. Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

Numerous other embodiments are also contemplated. These include embodiments that have fewer, additional, and/or different components, steps, features, objects, benefits and advantages. These also include embodiments in which the components and/or steps are arranged and/or ordered differently.

Embodiments of the present disclosure are described herein with reference to a flowchart illustration and/or block diagram of a method, apparatus (systems), and computer program products according to embodiments of the present disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of an appropriately configured computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a manner, such that the computer readable storage medium having instructions stored therein comprises an article of manufacture including instructions which implement embodiments of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The call-flow, flowchart, and block diagrams in the figures herein illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the blocks may occur out of order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While the foregoing has been described in conjunction with exemplary embodiments, it is understood that the term “exemplary” is merely meant as an example, rather than the best or optimal. Except as stated immediately above, nothing that has been stated or illustrated is intended or should be interpreted to cause a dedication of any component, step, feature, object, benefit, advantage, or equivalent to the public, regardless of whether it is or is not recited in the claims.

It will be understood that the terms and expressions used herein have the ordinary meaning as is accorded to such terms and expressions with respect to their corresponding respective areas of inquiry and study except where specific meanings have otherwise been set forth herein. Relational terms such as first and second and the like may be used solely to distinguish one entity or action from another without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a” or “an” does not, without further constraints, preclude the existence of additional identical elements in the process, method, article, or apparatus that comprises the element.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments have more features than are expressly recited in each claim. Rather, as the following claims reflect, the inventive subject matter lies in less than all features of a single disclosed embodiment. Thus, the following claims are hereby incorporated into the Detailed Description, with each claim standing on its own as a separately claimed subject matter.

What is claimed is:

1. A system comprising:
a movable object;
one or more sensors within the movable object to detect movement of the movable object; and
a classical computing machine, wherein the classical computing machine:
determines movement of the movable object and converts the movement into a rotation of the movable object; and
implements the rotation into a quantum circuit.

2. The system of claim 1, wherein the movable object is a sphere.

3. The system of claim 2, wherein the one or more sensors are positioned at an origin of the sphere.

4. The system of claim 2, wherein the rotation is spherical rotation.

5. The system of claim 4, wherein the spherical rotation includes rotation in one or more of an x-axis, a y-axis, and a z-axis.

6. The system of claim 1, wherein the one or more sensors includes a gyroscopic sensor.

7. The system of claim 1, wherein the one or more sensors includes a magneto-resistive sensor.

8. The system of claim 1, wherein the one or more sensors includes an accelerometric sensor.

9. The system of claim 1, wherein the classical computing machine displays the movement on a Bloch sphere simulator.

10. The system of claim 1, wherein the classical computing machine provides the quantum circuit to a quantum computing programming library.

11. The system of claim 1, wherein the classical computing machine permits manipulation of a plurality of the movable object, each representing a qubit of the quantum circuit.

12. A quantum state visualization device comprising:
one or more spheres;
one or more sensors within each of the one or more spheres;
a classical computing machine, wherein the classical computing machine:
determines movement of each of the one or more spheres and converts the movement into a spherical rotation of each of the one or more spheres; and
implements the spherical rotation into a quantum circuit.

13. The quantum state visualization device of claim 12, wherein the one or more sensors are positioned at an origin of the corresponding sphere.

14. The quantum state visualization device of claim 12, wherein the one or more sensors includes one or more of a gyroscopic sensor, a magneto-resistive sensor, or an accelerometric sensor.

15. The quantum state visualization device of claim 12, wherein the classical computing machine displays the movement on a Bloch sphere simulator.

16. The quantum state visualization device of claim 12, wherein the classical computing machine provides the quantum circuit to a quantum computing programming library.

17. A method for visualizing a quantum state on a three-dimensional quantum state visualization device, the method comprising:
manipulating one or more spheres;
determining spherical rotation of each of the one or more spheres with one or more sensors disposed within each of the one or more spheres;
implementing the spherical rotation into a quantum circuit; and
displaying the quantum state of the quantum circuit on a display.

18. The method of claim 17, wherein the manipulating of the one or more spheres is performed with a mouse, a track ball, or a joystick.

19. The method of claim 17, wherein the one or more sensors includes one or more of a gyroscopic sensor, a magneto-resistive sensor, or an accelerometric sensor.

20. The method of claim 17, wherein the display is a Bloch sphere simulator.
